(19) United States
(12) Patent Application Publication
(10) Pub. No.: US 2013/0044922 A1
(43) Pub. Date: Feb. 21, 2013

(54) INFORMATION PROCESSING DEVICE, INFORMATION PROCESSING METHOD, PROGRAM, AND INFORMATION PROCESSING SYSTEM

(71) Applicant: Akimitsu HIO, Tokyo (JP)

(72) Inventor: Akimitsu HIO, Tokyo (JP)

(73) Assignee: Sony Corporation, Tokyo (JP)

(21) Appl. No.: 13/562,720

(22) Filed: Jul. 31, 2012

(30) Foreign Application Priority Data
Aug. 16, 2011 (JP) 2011-177830

(51) Int. Cl. G06K 9/00

(52) U.S. Cl. 382/118

(57) ABSTRACT

An information processing device includes: a face information acquisition unit that acquires face information on a face region detected from an image containing a face of a participant who is collecting specific information provided in display devices respectively installed at plural locations and is using a display device installed at a location; an identification unit that identifies the participant by checking the acquired face information of the participant against registration information on face regions of pre-registered registrants; an action history information acquisition unit that selects the registrants similar to the identified participant as candidates from the registrants and acquires action history information on histories of actions when those candidates collect the specific information; and a presentation unit that presents the acquired action history information to the participant who is using the display unit.

### FIELD

The present disclosure relates to an information processing device, an information processing method, a program, and an information processing system, and specifically, to an information processing device, an information processing method, a program, and an information processing system that can improve authentication accuracy while protecting personal information.

### BACKGROUND

Recently, advertising media called digital signage of displaying images and information by display devices such as flat displays or projectors using digital technologies for display and communication have been widespread. In the digital signage, display information may be constantly received from a predetermined server, and thus, various image advertisements such that display contents are switched at rates of seconds and moving images are displayed may be developed by holding a lot of display information in a built-in memory.

Further, events of accumulating points called point rallies on predetermined themes in shops, stations, sightseeing spots, etc., for example, have been carried out (for example, see Patent Document 1 (JP-A-2000-218033) and Patent Document 2 (JP-A-2004-355353)).

When a point rally is provided as service using digital signage, participants who are using a display device installed at a certain location are authenticated and a visit point is provided only to valid participants. As the authentication processing, face authentication processing using information obtained by imaging of images of the faces of participants may be performed in place of a system using IDs or passwords input by the participants.

Further, as the authentication processing, authentication using past action history information of users may be performed (for example, see Patent Document 3 (JP-A-2008-158683)).

### SUMMARY

In a point rally using digital signage, when authentication of participants is performed by face authentication processing, if the authentication rate of face authentication is low, it may be impossible to identify the participants. In this case, it may be possible to present personal information for identification of the participants for the participants to select, however, if personal information including names is presented on a display device provided in a public place, the information may be disclosed to a third party, and the presentation is not preferable for protection of personal information.

Further, Patent Document 3 has disclosed presentation of past action history information of users, however, it may be impossible to present action history information of others than the users, and if plural candidate users exist in registrants registered in advance, the candidates may not be narrowed down.

It is therefore desirable to improve authentication accuracy while protecting personal information processing, when plural participant candidates exist in the registrants in face authentication by presenting action history information of the candidates and narrowing down the candidates.

An embodiment of the present disclosure is directed to an information processing device including a face information acquisition unit that acquires face information on a face region detected from an image containing a face of a participant who is collecting specific information provided in display devices respectively installed at plural locations and using a display device installed at a location, an identification unit that identifies the participant by checking the acquired face information of the participant against registration information on face regions of pre-registered registrants, an action history information acquisition unit that selects the registrants similar to the identified participant as candidates from the registrants and acquires action history information on histories of actions when those candidates collect the specific information, and a presentation unit that presents the acquired action history information to the participant who is using the display unit.

The device may further include a specific information provision unit that provides the specific information to the candidates identified by a selection result of the participant with respect to the presented action history information.

If it may be impossible to identify the candidates according to the selection result of the participant with respect to the action history information, the presentation unit may further present the action history information of the narrowed down candidates.

The action history information may at least include information on installation locations of the display devices at which the candidates have collected the specific information and information on times of the collection.

The device may further include a personal identification information acquisition unit that, if the candidates have been identified according to the selection result of the participant with respect to the presented action history information, acquires personal identification information on the identified candidates that can be identified only by the participant, wherein the presentation unit presents the acquired personal identification information to the participant who is using the display device.

The device may further include a specific information provision unit that provides the specific information to the candidates identified according to the selection result of the participant with respect to the presented personal identification information.

The specific information may be visit points provided when the participant visits the locations where the display devices are installed in a point rally as an event of accumulating points in a predetermined theme, and the specific information provision unit may provide the visit points as the specific information.

Another embodiment of the present disclosure is directed to an information processing method and a program corresponding to the information processing device according to the embodiment of the present disclosure.

In the information processing device, the information processing method, and the program according to the embodiments of the present disclosure, face information on the face region detected from the image containing the face of the participant who is collecting specific information provided in display devices respectively installed at plural locations and using a display device installed at a location is acquired, the participant is identified by checking the acquired face information of the participant against registration information on face regions of pre-registered registrants, the registrants similar to the identified participant are selected as candidates from the registrants and action history information on histories of actions when those candidates collect the specific information is acquired, and the acquired action history information is presented to the participant who is using the display unit.

Still another embodiment of the present disclosure is directed to an information processing system including display devices and an information processing device, and each of the display devices includes an imaging unit that takes an image containing a face of a participant who is collecting specific information provided in display devices respectively installed at plural locations and using a display device installed at a location, a face detection unit that detects a face region of the participant from the taken image, a first transmitting unit that transmits face information on the detected face region to the information processing device, a first receiving unit that receives action history information on histories of actions when registrants as candidates similar to the participant identified by checking the face information against registration information on face regions of pre-registered registrants transmitted from the information processing device collect the specific information, a presentation unit that presents the received action history information to the participant, and a selection input unit that accepts selection by the participant with respect to the presented action history information, wherein the first transmitting unit transmits an accepted selection result by the participant to the information processing device, and the information processing device includes a second receiving unit that receives the face information transmitted from the display device, an identification unit that identifies the participant by checking the received face information against the registration information, an action history information acquisition unit that selects the registrants similar to the identified participant as candidates from the registrants and acquires the action history information of those candidates, a second transmitting unit that transmits the acquired action history information to the display device, and a specific information provision unit that provides the specific information to the candidates identified according to a selection result of the participant transmitted from the display device.

The information processing device and the display device may be independent devices or internal blocks forming one equipment.

In the information processing system according to the embodiment of the present disclosure, by the display device, the image containing the face of the participant who is collecting specific information provided in display devices respectively installed at plural locations and using a display device installed at a location is taken, the face region of the participant is detected from the taken image, the face information on the detected face region is transmitted to the information processing device, the action history information on histories of actions when the registrants as candidates similar to the participant identified by checking the face information against registration information on face regions of pre-registered registrants transmitted from the information processing device collect the specific information is received, the received action history information is presented to the participant, and selection by the participant with respect to the presented action history information is accepted, wherein a selection result by the accepted participant is transmitted to the information processing device, and, by the information processing device, the face information transmitted from the display device is received, the participant is identified by checking the received face information against the registration information, the registrants similar to the identified participant are selected as candidates from the registrants and the action history information of those candidates is acquired, the acquired action history information is transmitted to the display device, and the specific information is provided to the candidates identified according to the selection result of the participant transmitted from the display device.

According to the embodiments of the present disclosure, authentication accuracy may be improved while personal information including names is protected.

### BRIEF DESCRIPTION OF THE DRAWINGS

FIG. 1 shows a configuration of a digital signage system.

FIG. 2 shows an appearance example of a display device.

FIG. 3 shows a configuration example of the display device and a data server.

FIG. 4 shows a detailed configuration example of a data processing unit.

FIG. 5 is a diagram for explanation of an outline of point rally service.

FIG. 6 shows an example of a personal database.

FIG. 7 is a flowchart for explanation of point rally provision processing of the display device.

FIG. 8 is a flowchart for explanation of action history information provision presentation processing of the display device.

FIG. 9 shows an example of window transition.

FIG. 10 is a flowchart for explanation of point rally provision processing of the data server.

FIG. 11 is a flowchart for explanation of action history information provision presentation processing of the data server.

FIG. 12 shows a configuration example of a computer.

### DETAILED DESCRIPTION

Hereinafter, embodiments of the present disclosure will be explained with reference to the drawings.

### [Configuration Example of Digital Signage System]

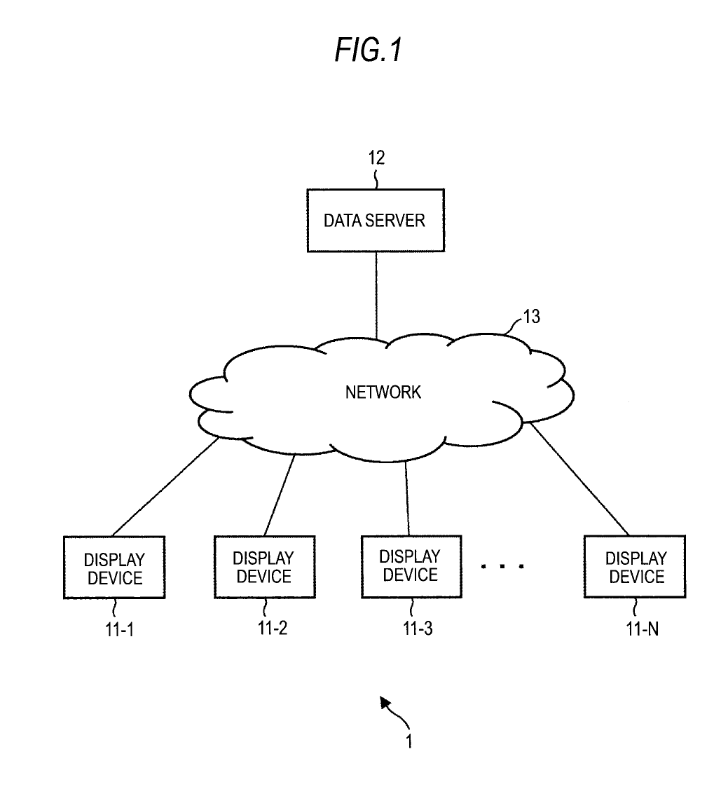

FIG. 1 shows a configuration of a digital signage system 1.

The digital signage system 1 is a system of providing service of a point rally or the like, for example.

As shown in FIG. 1, the digital signage system 1 includes display devices 11-1 to 11-N (N=1, 2, 3, . . . , n) and a data server 12. The respective display devices 11-1 to 11-N and the data server 12 are mutually connected via a network 13.

The display device 11-1 is installed on a wall or a desk of a facility of a shop, a station, a sightseeing spot, or the like. The display device 11-1 has a display unit such as an LCD (Liquid Crystal Display) or an organic EL (Electro Luminescence) display, and receives contents transmitted from the data server 12 via the network 13 and display the contents thereon.

The display devices 11-2 to 11-N have the same configuration as that of the display device 11-1 and receive contents transmitted from the data server 12 via the network 13 and display the contents thereon.

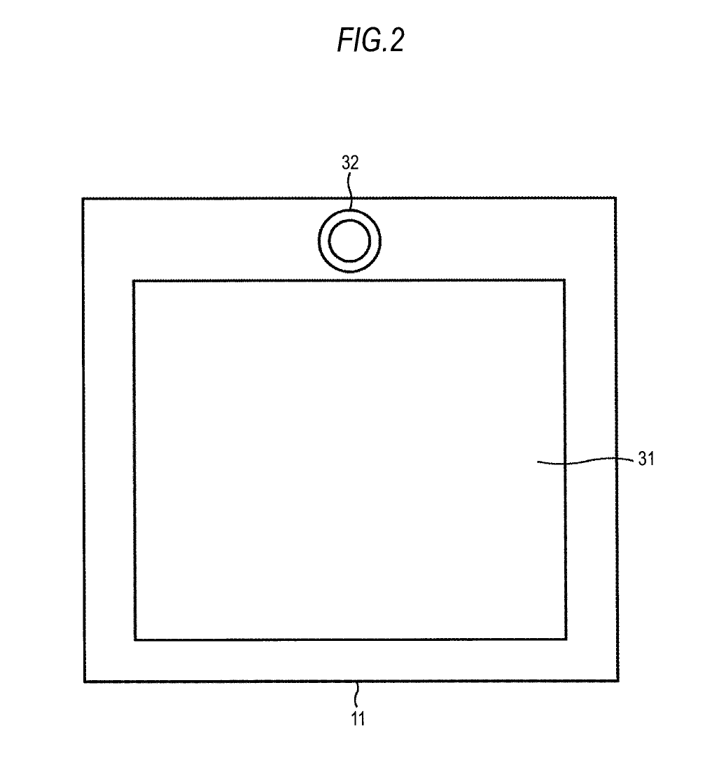

Note that, in the case where it is not necessary to specifically distinguish the display devices 11-1 to 11-N, they will be explained as “display device 11”. Further, as shown in FIG. 2, in the display device 11, a display unit 31 for displaying contents etc. transmitted from the data server 12 is provided, and an imaging unit 32 for imaging a participant who is using the display device 11 at authentication is further provided on the upper part of the display unit 31.

Returning to FIG. 1, the data server 12 holds contents to be displayed on the display device 11, and transmits the contents to the display device 11 via the network 13.

When performing authentication of a participant who is using the display device 11-1, the display device 11-1 acquires information on a face region recognized from an image containing a face of the participant (hereinafter, referred to as “face authentication information”) and transmits the information to the data server 12 via the network 13.

The data server 12 manages information on authentication of pre-registered registrants (hereinafter, referred to as “registration authentication information”) as participants who can use the service provided by the digital signage system 1 and information on action histories of the registrants (hereinafter, referred to as “action history information”). The data server 12 performs face authentication processing of the participant by checking the face authentication information of the participant transmitted from the display device 11-1 against the registration authentication information of the registrants and transmits the action history information in response to the result of the face authentication to the display device 11-1 via the network 13.

The display device 11-1 receives the action history information transmitted from the data server 12 via the network 13 and displays the information on the display unit 31. The display device 11-1 accepts selection with respect to the displayed action history information by the participant, and transmits the selection result to the data server 12 via the network 13. Then, the data server 12 provides specific information to the participant in response to the selection result transmitted from the display device 11-1.

Further, in the display devices 11-2 to 11-N, as in the display device 11-1, face authentication processing of participants is performed between the data server 12 and themselves, and specific information is provided to valid participants.

The digital signage system 1 has the following configuration.

### [Configuration Example of Display Device and Data Server]

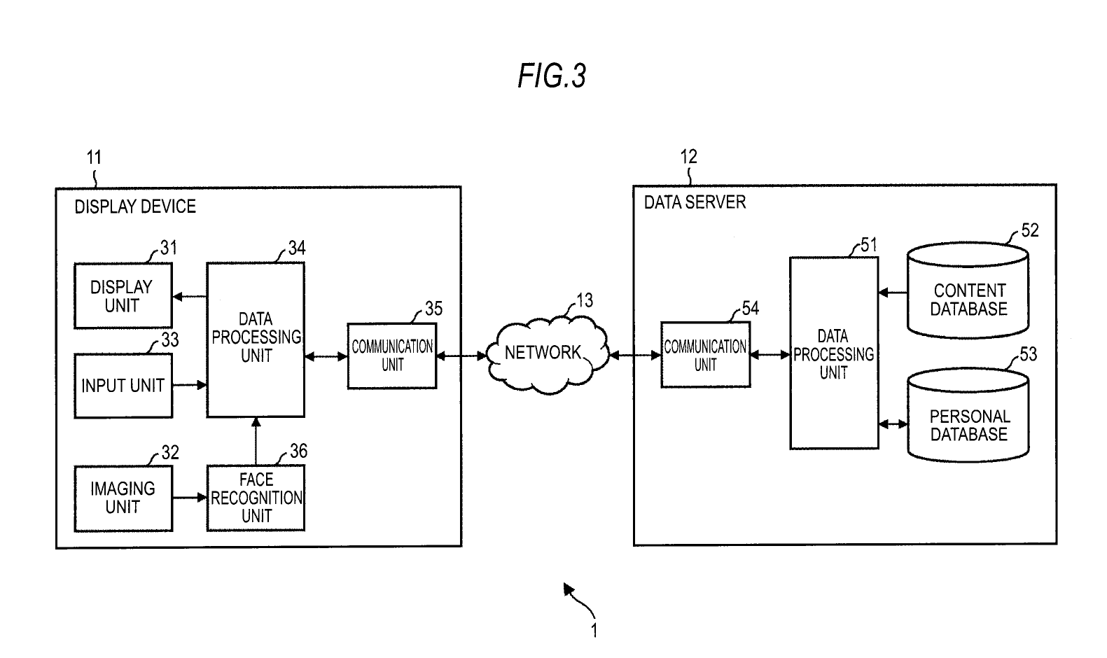

FIG. 3 shows a detailed configuration example of the display device 11 and the data server 12 forming the digital signage system 1 in FIG. 1.

As shown in FIG. 3, the display device 11 includes the display unit 31, the imaging unit 32, an input unit 33, a data processing unit 34, a communication unit 35, and a face recognition unit 36.

The communication unit 35 receives content data transmitted from the data server 12 via the network 13 and supplies the data to the data processing unit 34.

The data processing unit 34 performs predetermined image processing for display on the display unit 31 on the content data supplied from the communication unit 35, and supplies the resulting content data to the display unit 31.

The display unit 31 displays the contents corresponding to the content data supplied from the data processing unit 34.

The imaging unit 32 images the participant who is using the display device 11, and supplies image data obtained by the imaging to the face recognition unit 36. The taken image contains at least the face of the participant.

The face recognition unit 36 detects the face region from the taken image corresponding to the image data supplied from the imaging unit 32. As a detection method of the face region, for example, within the taken image, correlation values are obtained while a previously prepared template is moved in the image, and thereby, the region in which the highest correlation value is obtained may be determined as the face region of the participant. Note that, here, techniques of other face region extraction methods may be employed.

Then, the face recognition unit 36 detects locations of organs such as eyes, a nose, a mouth, eyebrows, ears, and hair, for example, from parts of the detected face region. As a detection method of the organs, known technologies disclosed in various documents may be used. Then, the face recognition unit 36 cuts out the face region in fixed size and shape according to the detected locations of the organs, and uses grayscale information thereof as feature quantities of the face image of the participant.

The face recognition unit 36 supplies the feature quantities of the face image obtained using various techniques as face authentication information of the participant to the communication unit 35 via the data processing unit 34. The communication unit 35 transmits the face authentication information of the participant to the data server 12 via the network 13.

The communication unit 35 receives the action history information transmitted from the data server 12 via the network 13 and supplies the information to the data processing unit 34.

The data processing unit 34 presents the action history information supplied from the communication unit 35 by displaying the information on the display unit 31. Further, the display unit 31 is formed as a touch panel display. When the participant touches or comes close to the touch panel display with a finger or the like, for example, the input unit 33 supplies location information thereof to the data processing unit 34.

The data processing unit 34 supplies selection results for the contents, the action history information, etc. displayed on the display unit 31 by the participant to the communication unit 35 in response to the location information supplied form the input unit 33.

The communication unit 35 transmits the selection results supplied from the data processing unit 34 to the data server 12 via the network 13. The communication unit 35 receives various information transmitted from the data server 12 in response to the selection results via the network 13, and supplies the information to the data processing unit 34.

The data processing unit 34 performs predetermined image processing on the various information supplied from the communication unit 35 and supplies and displays the information on the display unit 31.

The display device 11 has the above described configuration.

As shown in FIG. 3, the data server 12 includes a data processing unit 51, a content database 52, a personal database 53, and a communication unit 54.

The data processing unit 51 performs processing on various data. The data processing unit 51 acquires content data from the content database 52 and supplies the data to the communication unit 54. The communication unit 54 transmits the content data supplied from the data processing unit 51 to the display device 11 via the network 13. Note that, in the content database 52, data of contents including various images and character information to be presented on the display device 11 are stored in advance.

The communication unit 54 receives the face authentication information of the participant transmitted from the display device 11 via the network 13 and supplies the information to the data processing unit 51.

Further, the communication unit 54 receives the selection results of the participant transmitted via the network 13 and supplies the results to the data processing unit 51. The data processing unit 51 acquires various information based on the selection results supplied from the communication unit 54 and supplies the information to the communication unit 54. Then, the communication unit 54 transmits the various information supplied from the data processing unit 51 to the display device 11 via the network 13.

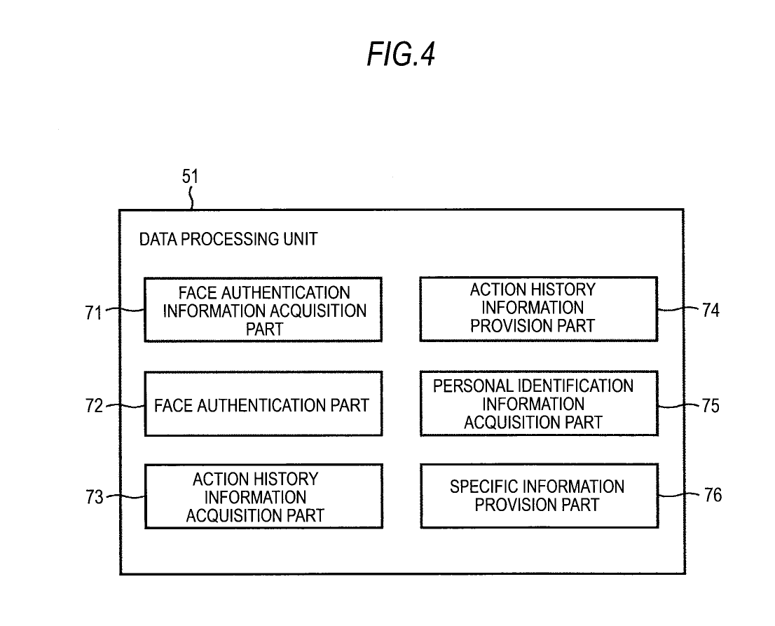

As shown in FIG. 4, the data processing unit 51 has a face authentication information acquisition part 71, a face authentication part 72, an action history information acquisition part 73, an action history information provision part 74, a personal identification information acquisition part 75, and a specific information provision part 76.

The face authentication information acquisition part 71 acquires the face authentication information supplied from the communication unit 54 and supplies the information to the face authentication part 72.

The face authentication part 72 performs face authentication processing of the participant who is using the display device 11 by checking the face authentication information acquired by the face authentication information acquisition part 71 against the registration authentication information pre-registered in the personal database 53.

Note that, in the personal database 53, personal information of pre-registered registrants as participants who can use the service provided by the digital signage system 1 is stored. The personal information contains the registration authentication information as information on face images of the registrants. Further, in the personal database 53, in addition to the personal information of the registrants, at least action history information on action histories of the registrants and specific information provided to the registrants are stored.

The action history information acquisition part 73 selects the registrants similar to the authenticated participant as candidates from the registrants registered in the personal database 53 based on the result of the face authentication by the face authentication part 72. Then, the action history information acquisition part 73 acquires the action history information of the selected plural candidates with reference to the personal database 53 and supplies the information to the action history information provision part 74.

The action history information provision part 74 controls the communication unit 54 to transmit the action history information to the display device 11 via the network 13. Thereby, the action history information is provided to the display device 11 and displayed on the display unit 31, and the action history information is presented to the participant who is using the display unit 31.

When the candidates are identified by the selection result supplied from the communication unit 54, the personal identification information acquisition part 75 acquires personal identification information such as initials information of the names of the candidates that can be identified only by the participants themselves with reference to the personal database 53 and supplies the information to the communication unit 54. Then, the communication unit 54 transmits the personal identification information supplied from the personal identification information acquisition part 75 to the display device 11 via the network 13.

When the candidates are identified by the selection result supplied from the communication unit 54, the specific information provision part 76 provides specific information to the candidates with reference to the personal database 53. That is, specific information is provided to the registrants narrowed down as the candidates registered in the personal database 53.

The data server 12 has the above described configuration.

Note that, in the embodiment, the example using feature quantities obtained from the above described face images as the face authentication information and the registration authentication information is explained, however, for example, face images acquired from the participants may be used as they are, not limited to the example.

### [Specific Example of Service]

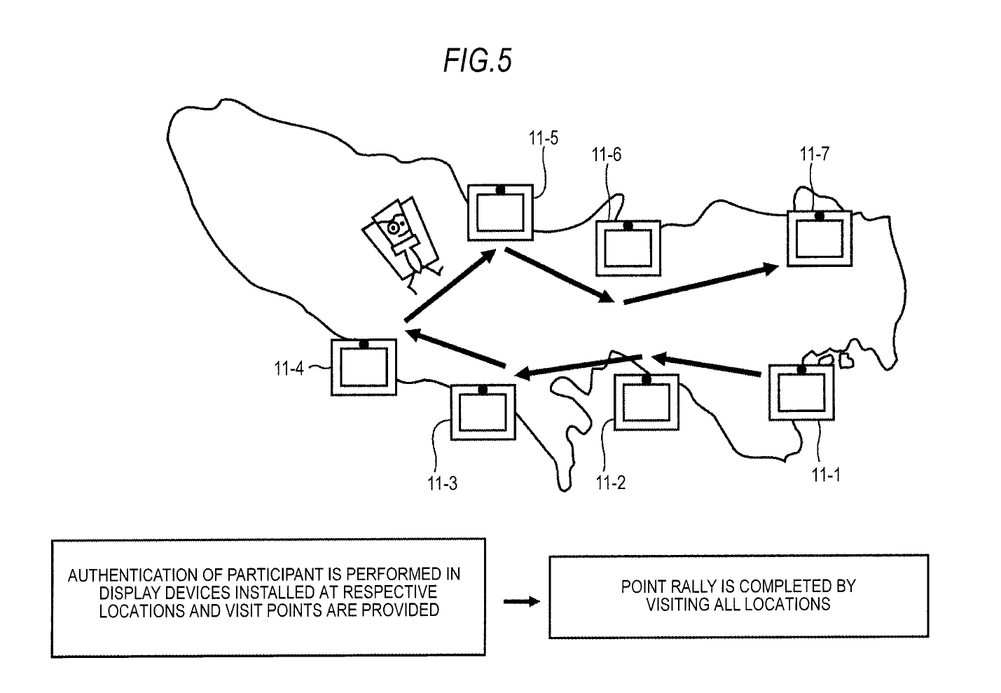

Next, a point rally will be explained as an example of service provided by the digital signage system 1 with reference to FIGS. 5 to 11.

### [Outline of Point Rally]

FIG. 5 is a diagram for explanation of an outline of a point rally.

A point rally is an event of accumulating points on a predetermined theme in shops, stations, sightseeing spots, etc. Participants of the point rally collect points provided in the display devices 11 respectively installed at plural locations.

As shown in FIG. 5, by the display devices 11 installed in the shops and stations at the respective locations of “Shinagawa”, “Komae”, “Machida”, “Hachioji”, “Fussa”, “Hibarigaoka”, and “Ueno”, for example, authentication of the participants visiting the respective locations is performed, and, when the authentication is successful, visit points are provided to the participants. The participants visit all of the locations and visit points are provided from the display devices 11 installed at the respective locations, and thereby, the point rally is completed.

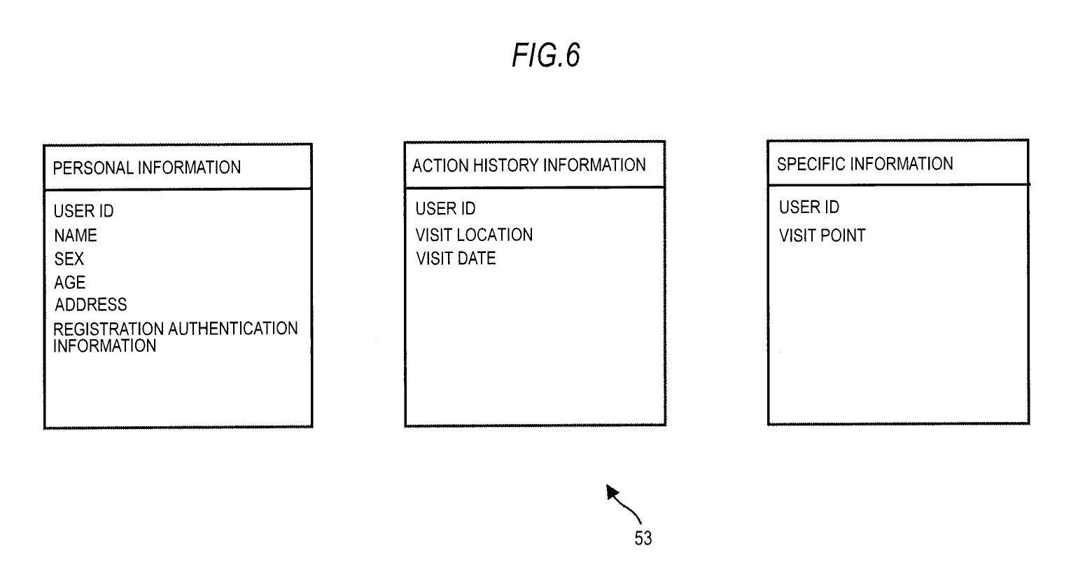

Further, as described above, the information on the display devices 11 installed at the respective locations is intensively managed by the data server 12, and, when the service of the digital point rally is provided by the digital signage system 1, for example, information shown in FIG. 6 is stored in the personal database 53.

As shown in FIG. 6, personal information, action history information, and specific information are stored in the personal database 53. The personal information is information pre-registered by participants in advance, and, for example, in addition to personal information including user IDs, names, sexes, ages, addresses, registration authentication information is registered as information on face images of the participants to be used for authentication.

The action history information is information on action histories when the participants visit the respective locations and collect visit points using the display devices 11, and, for example, visit locations and visit dates associated with the user IDs of the respective participants are registered. Further, the specific information is information provided to the participants visiting the respective locations, and, for example, visit points associated with the user IDs of the respective participants are registered.

When the point rally service is provided, the above described information is registered in the personal database 53.

### [Point Rally Provision Processing]

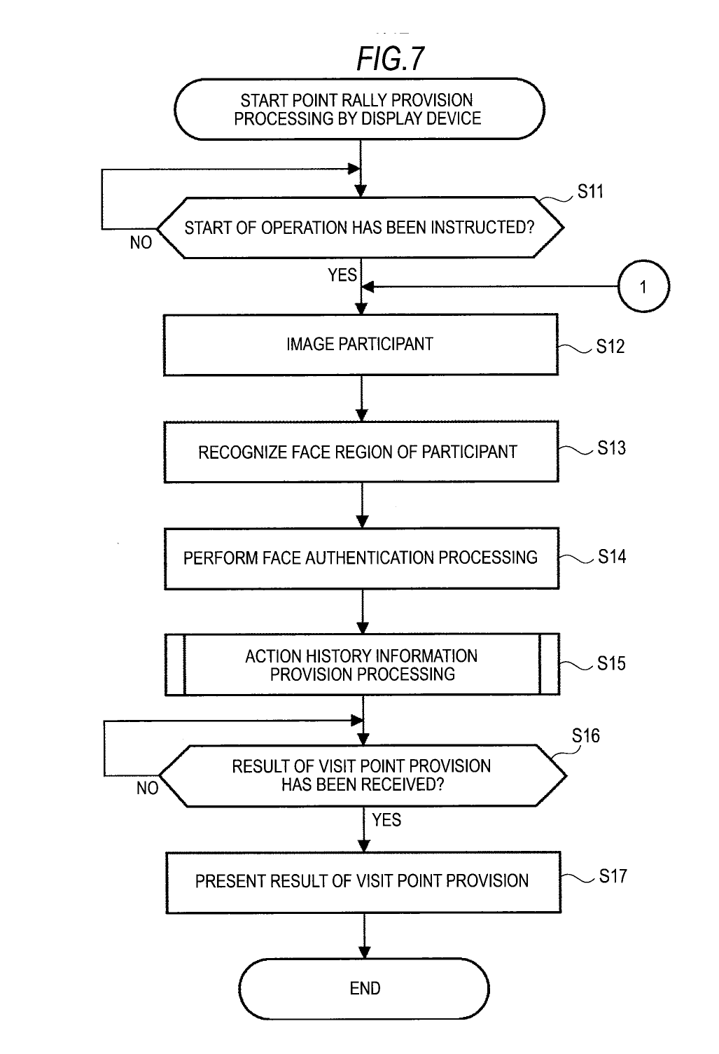

Next, processing for providing point rally service that is executed by the display device 11 and the data server 12 will be explained with reference to FIGS. 7 to 11.

First, the point rally service provision processing by the display device 11 will be explained with reference to the flowchart in FIG. 7.

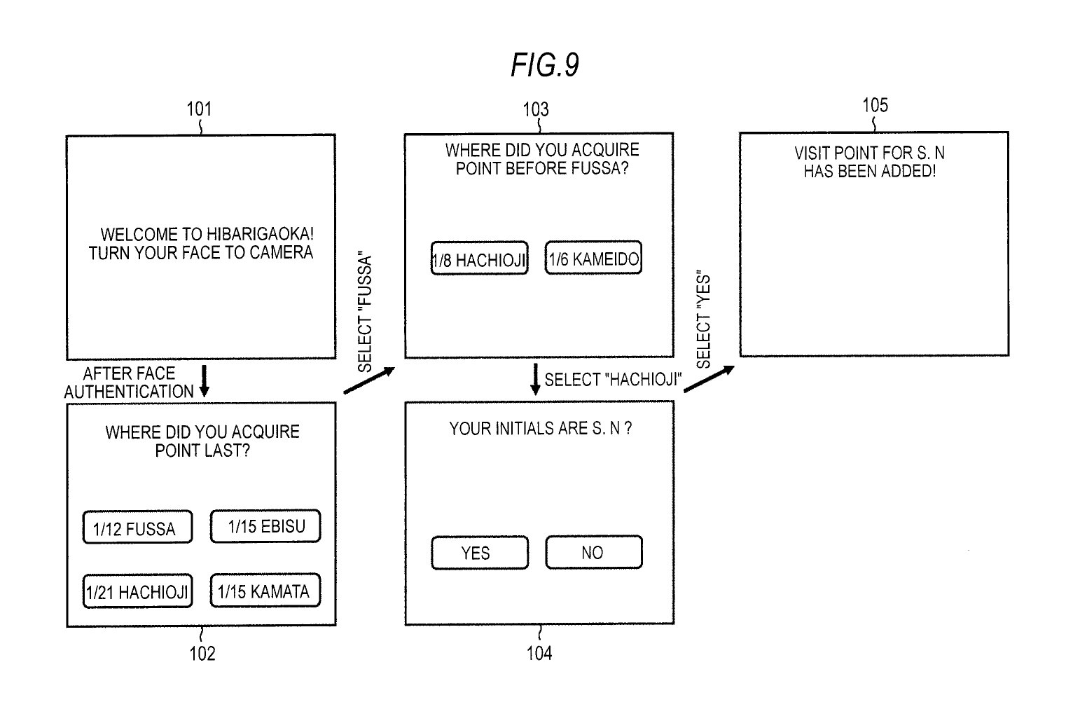

If the participant of the point rally gives an instruction to start operation to the display device 11 installed at the visit location among the display devices 11-1 to 11-7 installed at the plural locations of Shinagawa, Komae, etc. (“Yes” at step S11), the process proceeds to step S12. For example, the participant is using the display device 11-6 installed at Hibarigaoka, an initial window 101 in FIG. 9 is displayed on the display unit 31 thereof.

Returning to FIG. 7, at step S12, the imaging unit 32 takes an image of the face of the participant who is using the display device 11.

At step S13, the face recognition unit 36 recognizes the face region of the participant from the taken image taken by the imaging unit 32. In the recognition of the face region, for example, within the taken image, correlation values are obtained while a previously prepared template is moved in the image, the region in which the highest correlation value is obtained is determined as the face region of the participant, locations of organs are detected from the parts of the face region, and feature quantities of the face image are obtained from the locations of the organs.

If the feature quantities of the face image are obtained as face authentication information by the processing at step S13, the process proceeds to step S14, and face authentication processing is performed. In the face authentication processing, for example, the communication unit 35 transmits the face authentication information to the data server 12 via the network 13, the face authentication information of the participant is checked against the registration authentication information of the registrants by the data server 12, and thereby, the face authentication processing of the participant is performed. Then, in the data server 12, the registrants similar to the authenticated participant are selected as candidates from the registrants, and action history information of the candidates is acquired and transmitted to the display device 11 via the network 13.

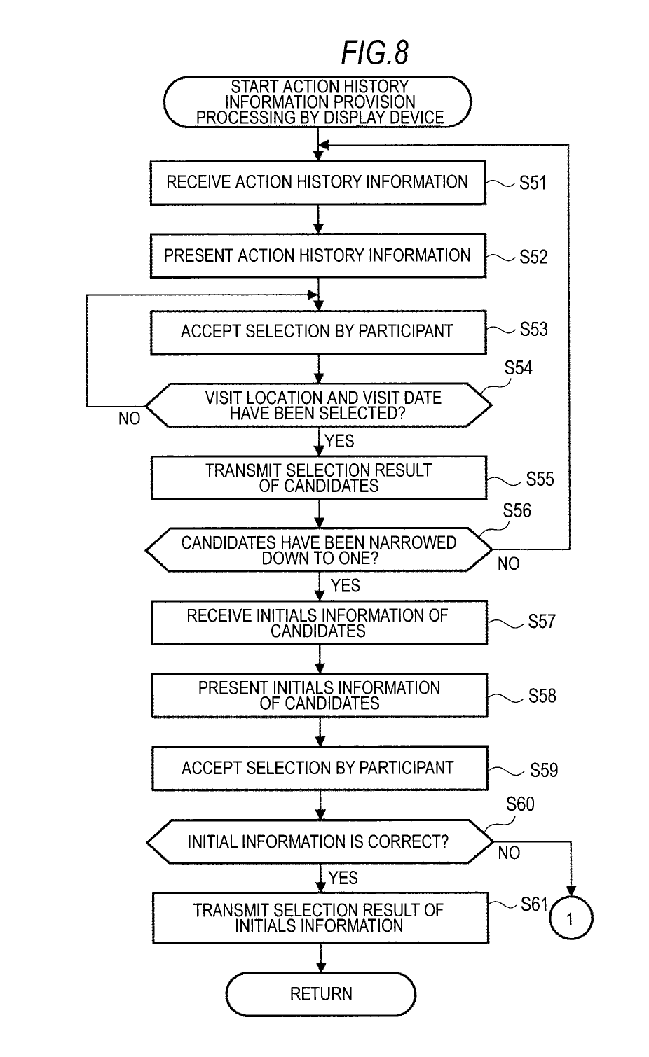

If the action history information is transmitted to the display device 11 by the data server 12 by the processing at step S14, the process proceeds to step S15, and action history information presentation processing is performed. Here, details of the action history information presentation processing will be explained with reference to the flowchart in FIG. 8.

At step S51, the communication unit 35 receives the action history information transmitted from the data server 12 via the network 13.

At step S52, the data processing unit 34 displays the action history information received by the communication unit 35 on the display unit 31. Here, as the action history information, for example, the last visit locations and visit dates of the candidates are presented to the participant who is using the display device 11.

At step S53, the input unit 33 accepts the selection by the participant with respect to the action history information displayed on the display unit 31.

At step S54, the data processing unit 34 determines whether or not the last visit location and visit date of the candidates have been selected by the participant based on location information from the input unit 33.

At step S54, if determination such that the last visit location and visit date of the candidates have been selected is made, the process is returned to step S53, and the above described steps S53, S54 are repeated until the visit location etc. are selected by the participant. Then, if the visit location etc. are selected by the participant (“Yes” at step S54), the process proceeds to step S55.

At step S55, the data processing unit 34 supplies the selection result of the candidates in response to the location information from the input unit 33 to the communication unit 35 to transmit the result to the data server 12 via the network 13. In the data server 12, whether or not the candidates have been narrowed down to one is determined based on the selection result of the candidate from the display device 11, and the determination result is transmitted to the display device 11 via the network 13.

If the determination result of narrowing down of the candidates is transmitted by the data server 12 by the processing at step S55, the process proceeds to step S56, and, if the candidates have not been narrowed down to one (“No” at step S56), the process is returned to step S51. Then, in the display device 11, as the action history information transmitted from the data server 12, for example, the second last visit locations and visit dates of the narrowed down candidates are displayed again, selected by the participant, and whether or not the candidates have been narrowed down to one is determined again. In this manner, the candidates are sequentially narrowed down on condition of the visit locations etc. selected by the participant, and finally, the candidates are narrowed down to one.

For example, on an action history window 102 in FIG. 9, by the first presentation of action history information, as the last visit locations and visit dates of the candidates, “1/12 Fussa”, “1/15 Ebisu”, “1/21 Hachioji”, and “1/15 Kamata” are displayed. The participant selects items matching with the last location and date at which the participant gained the visit point from his or her memory. Here, for example, “1/12 Fussa” is selected. Further, the candidate who visited Fussa on Jan. 12 is one as the last location where the participant gained the visit point, the candidate is the final candidate.

On the other hand, in the case where plural candidates who visited Fussa on Jan. 12 exist, by the second presentation of action history information, as the second last visit locations and visit dates of the narrowed down candidates, “1/8 Hachioji”, and “1/6 Kameido” are displayed on the action history window 103 in FIG. 9. Further, for example, “1/8 Hachioji” is selected, and the candidate who visited Hachioji on Jan. 8 is one as the second last location where the participant gained the visit point, the candidate is the final candidate.

Returning to FIG. 8, at step S56, if determination such that the candidates have been narrowed down to one is made, the process proceeds to step S57.

At step S57, the communication unit 35 receives initials information indicating the initials of the name of the candidate transmitted from the data server 12 via the network 13.

At step S58, the data processing unit 34 displays the initials information received from the communication unit 35 on the display unit 31. Thereby, on the display unit 31, an initials confirmation window 104 in FIG. 9 is displayed, and initials of the name of the candidate such as “S. N”, for example, are presented to the participant who is using the display device 11.

Returning to FIG. 8, at step S59, the input unit 33 accepts the selection by the participant on whether or not the presented initials information is correct.

At step S60, the data processing unit 34 determines whether or not the selection such that the initials information is correct has been made by the participant based on the location information from the input unit 33.

At step S60, for example, if “Yes” on the initials confirmation window 104 in FIG. 9 has been selected and selection such that the initials information is correct has been made, the process proceeds to step S61. At step S61, the data processing unit 34 supplies the selection result of the initials information in response to the location information from the input unit 33 to the communication unit 35 to transmit the information to the data server 12 via the network 13. Then, in the data server 12, a visit point is provided to the candidate who has been finally narrowed down based on the selection result of the initials information, and the result of visit point provision is transmitted to the display device 11 via the network 13.

Note that, at step S60, for example, if “No” on the initials confirmation window 104 in FIG. 9 has been selected and selection such that the initials information is incorrect has been made, the process is returned to step S12 in FIG. 7, and the face authentication processing is performed again from imaging of the image containing the face of the participant.

Then, the processing at step S61 is ended, the action history information presentation processing is ended, and the process is returned to step S15 in FIG. 7, and the subsequent processing is executed.

At step S16, the data processing unit 34 controls the communication unit 35 to determine whether or not the result of the visit point provision transmitted from the data server 12 via the network 13 has been received.

At step S16, if determination such that the result of the visit point provision has been received is made, the process proceeds to step S17. At step S17, the data processing unit 34 displays the result of the visit point provision received by the communication unit 35 on the display unit 31. Thereby, on the display unit 31, a visit point provision result window 105 in FIG. 9 is displayed, and, for example, a message saying “Visit Point for S. N has been added” or the like is presented to the participant who is using the display device 11.

Returning to FIG. 7, when the processing at step S17 is ended, the point rally provision processing by the display device 11 is ended.

In the above described manner, in the display device 11, the image containing the face of the participant is taken, the face region of the participant is recognized from the taken image, and the face authentication information on the face region is transmitted to the data server 12. Then, the action history information of the candidates in response to the authentication result of the face authentication processing is received and presented to the participant, the selection with respect to the presented action history information by the participant is received, and the selection result is transmitted to the data server 12. As a result, in the data server 12, the visit point is provided to the candidate who has been finally narrowed down in response to the selection result by the participant.

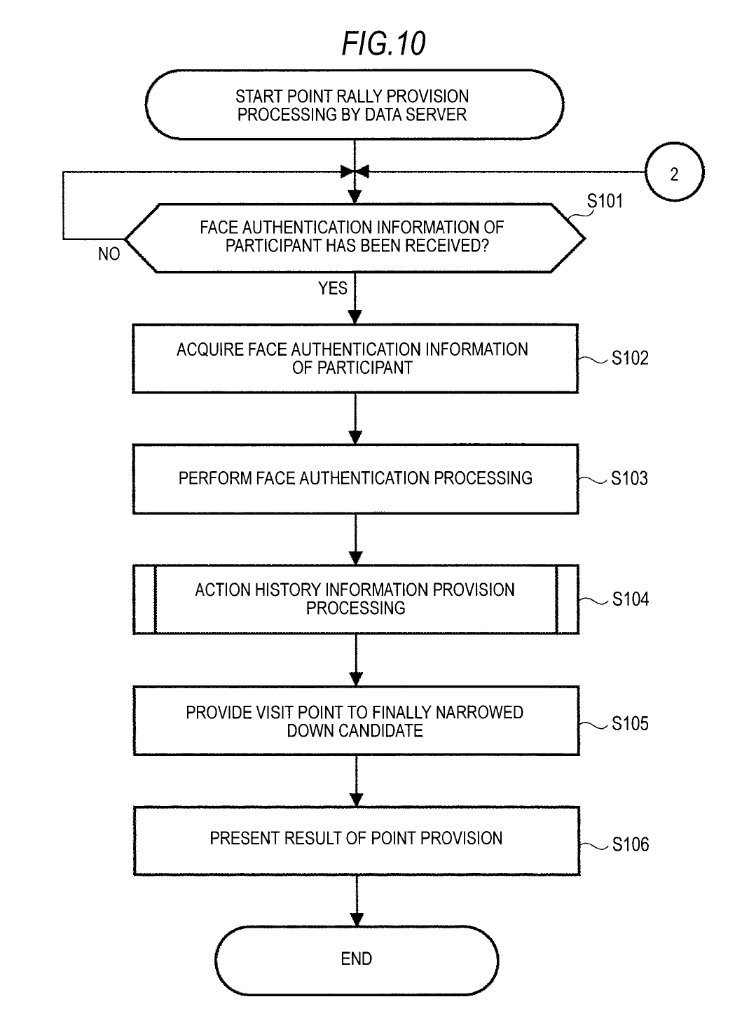

Next, the point rally provision processing by the data server 12 will be explained with reference to a flowchart in FIG. 10.

When the participant of the point rally uses the display device 11 installed at the visit location among the display devices 11-1 to 11-7 installed at the plural locations and face authentication processing is started, face authentication information is transmitted from the display device 11 via the network 13. Then, in the data server 12, the transmitted face authentication information of the participant is received (“Yes” at step S101), the process proceeds to step S102.

At step S102, the face authentication information acquisition part 71 acquires the face authentication information received by the communication unit 54.

At step S103, the face authentication part 72 performs face authentication of the participant who is using the display device 11 by checking the face authentication information acquired by the face authentication information acquisition part 71 against the registration authentication information of the registrants registered in the personal database 53. Specifically, for example, the feature quantities obtained from the face image of the participant is checked against the feature quantities of the face images of the registrants pre-registered in the personal database 53, and the similarity of them is calculated. In this regard, the registration authentication information of all of the registered registrants are checked against the face authentication information of the participant one-on-one, and respective similarities are calculated. Note that, as a calculation method of the similarities, known technologies disclosed in various documents may be used.

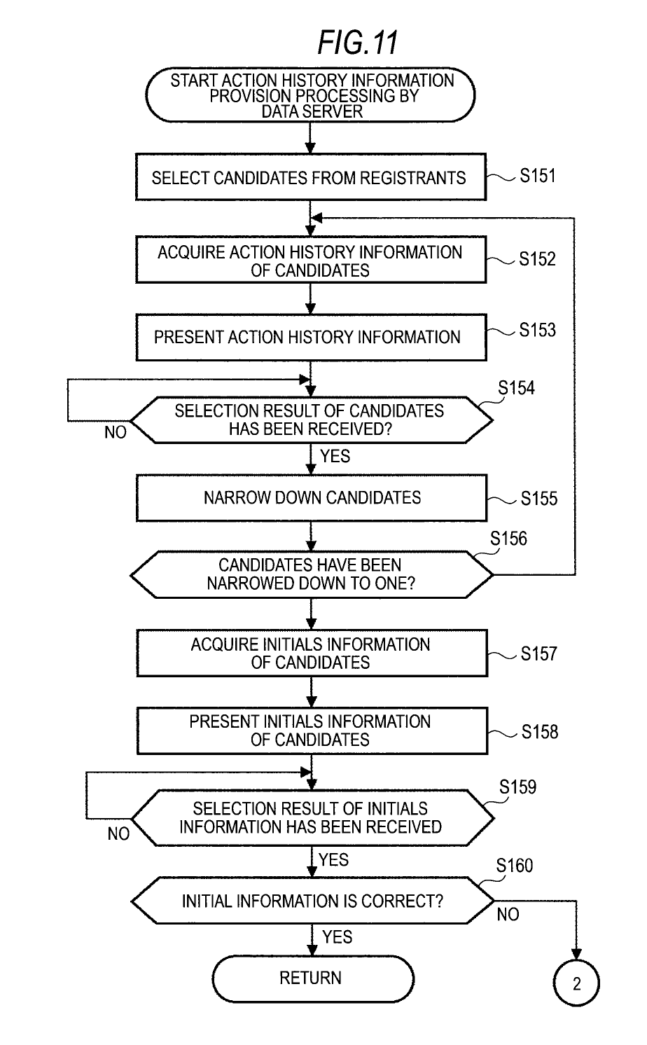

The face authentication processing is performed by the processing and the similarities of the feature quantities of the face images of the participant and the registrants are calculated by the processing at step S103, then, the process proceeds to step S104, and action history information provision processing is performed. Here, the details of the action history information provision processing will be explained with reference to a flowchart in FIG. 11.

At step S151, the action history information acquisition part 73 selects registrants similar to the participant as candidates from the registrants registered in the personal database 53 based on the result of the face authentication by the face authentication part 72. Specifically, for example, the similarities of all registrants with respect to the participant have been calculated by the face authentication processing, the registrants having the similarities exceeding a predetermined threshold value may be selected as the candidates.

At step S152, the action history information acquisition part 73 acquires the last visit locations and visit dates of the candidates as the action history information of the selected candidates with reference to the personal database 53.

At step S153, the action history information provision part 74 controls the communication unit 54 to transmit the action history information acquired by the action history information acquisition part 73 to the display device 11 via the network 13. Thereby, the action history information is provided to the display device 11 and displayed on the display unit 31, and the action history information is presented to the participant who is using the display unit 31.

At step S154, the data processing unit 51 controls the communication unit 54 to determine whether or not the selection result of the candidates transmitted from the display device 11 via the network 13 has been received.

At step S154, if determination such that the selection result of the candidates has been received is made, the process proceeds to step S155. At step S155, the action history information provision part 74 narrows down the candidates based on the selection result of the candidates, and determines whether or not the candidates have been narrowed down to one (step S156). That is, if there is only one candidate visiting the last visit location, the candidates have been narrowed down, however, if there are plural candidates visiting the last visit location, it is necessary to further narrow down the candidates.

At step S156, if there are plural candidates, the process is returned to step S152, and the above described processing is repeated. That is, if there are plural candidates visiting the last visit location, for example, the action history information containing the second last visit locations and visit dates of those candidates is acquired and transmitted to the display device 11 via the network 13. Then, the candidates are narrowed down again based on the selection result of the candidates by the participant who is using the display device 11, and whether or not the candidates have been narrowed down to one is determined. Then, the processing at steps S152 to S156 is repeated until the candidates are finally narrowed down to one.

At step S156, if the candidates have been narrowed down to one, the process proceeds to step S157. At step S157, the personal identification information acquisition part 75 acquires initials information obtained from the personal information of the candidate registered in the personal database 53. The initials information includes initials of the name of the candidate, for example, “S. N”. Note that, here, not only the initials information but also other personal identification information that can be identified only by the participant himself or herself such as pre-registered character information may be used.

At step S158, the communication unit 54 transmits the initials information acquired from the personal identification information acquisition part 75 to the display device 11 via the network 13.

At step S159, the personal identification information acquisition part 75 controls the communication unit 54 to determine whether or not the selection result of the initials information transmitted from the display device 11 via the network has been received.

At step S159, if the selection result of the initials information has been received, the process proceeds to step S160. At step S160, the personal identification information acquisition part 75 determines whether or not selection such that the initials information is correct information has been made by the participant based on the selection result of the initials information.

At step S160, if the selection such that the initials information is incorrect has been made, the process is returned to step S101 in FIG. 10, and the face authentication processing is performed again from the reception determination of the face authentication information of the participant.

On the other hand, if the selection such that the initials information is correct has been made, the action history information presentation processing is ended, the process is returned to step S104 in FIG. 10, and the subsequent processing is executed.

At step S105, the specific information provision part 76 provides a visit point to the finally narrowed down one candidate (registrant) with reference to the personal database 53.

At step S106, the specific information provision part 76 controls the communication unit 54 to display the result of the provided visit point to the display device 11 via the network 13.

When the processing at step S106 is ended, the point rally provision by the data server 12 is ended.

In the above described manner, in the data server 12, the face authentication information transmitted from the display device 11 is received, the participant is authenticated by checking the received face authentication information against the registration authentication information, the registrants similar to the authenticated participant are selected as candidates from the registrants, and the action history information of those candidates is acquired and transmitted to the display device 11. Then, the visit point is provided to the candidate identified by the selection result of the action history information of the candidates by the participant transmitted from the display device 11.

That is, when the face authentication information of the participant is performed, in the case where there are plural candidates of the participant among the pre-registered registrants, the candidates may be narrowed down by presenting the action history information of those candidates for selection. Accordingly, even the authentication method with an authentication rate of not 100% may improve the authentication accuracy by supplementarily presenting the action history information.

Further, the action history information that may not invade the privacy of the participant if disclosed to the third party is presented, and thus, also the personal information may be protected. Therefore, the authentication accuracy may be improved while the personal information is protected.

Note that, in the above described explanation, the face authentication information acquisition part 71 to the specific information provision part 76 in FIG. 4 are provided in the data processing unit 51, however, all or part of the face authentication information acquisition part 71 to the specific information provision part 76 in FIG. 4 may be provided in the data processing unit 34. That is, for example, at the data server 12 side, only the management of the content database 52 and the personal database 53 may be performed, and the face authentication information acquisition part 71 to the specific information provision part 76 provided at the display device 11 side may control the communication unit 35 to connect to the data server 12 via the network 13 and perform the same processing of the face authentication information acquisition part 71 to the specific information provision part 76 in FIG. 4.

As described above, in the digital signage system 1, part or all of the processing performed by the face authentication information acquisition part 71 to the specific information provision part 76 in FIG. 4 may be arbitrarily performed at the data server 12 side or the display device 11 side, and the configuration in FIG. 4, for example, is employed as an example of the configuration.

Further, in the above described explanation, the display device 11 is formed by integration of the display function and the control function thereof, however, those functions may be realized by separate devices. That is, for example, the display device 11 may include a display device having the display unit 31, the imaging unit 32, and the input unit 33 and a control device having the data processing unit 34, the communication unit 35, and the face recognition unit 36.

[Explanation of Computer with Application of the Technology]

The above described series of processing may be performed by hardware or software. When the series of processing is performed by software, a program forming the software is installed in a general-purpose computer or the like.

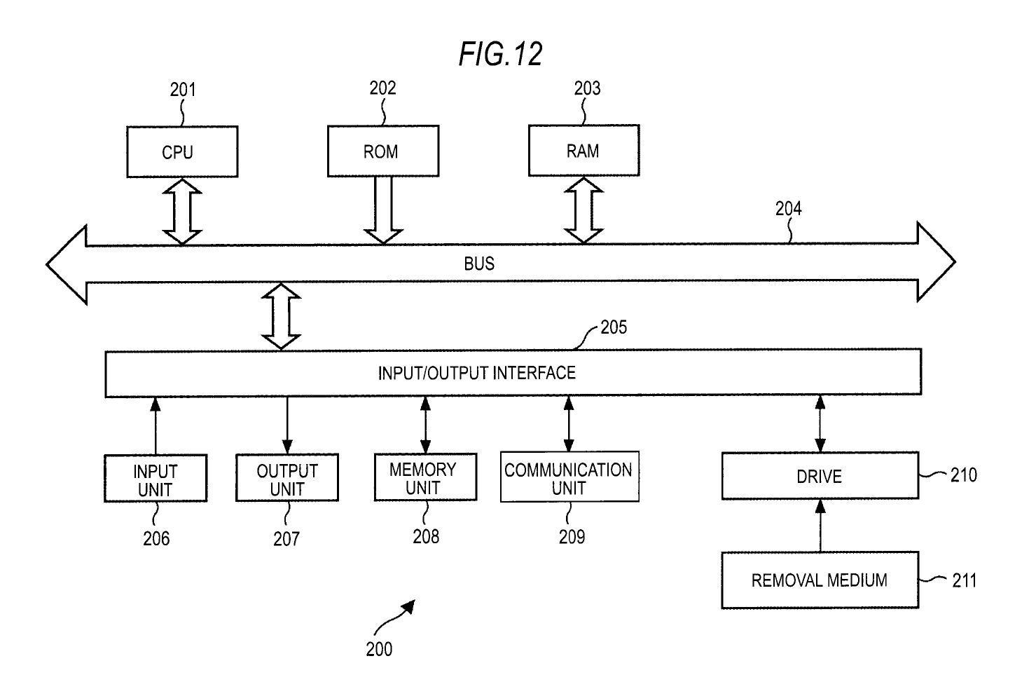

FIG. 12 shows a configuration example of one embodiment of a computer in which the program for executing the above described series of processing is installed.

The program may be recorded in advance in a memory unit 208 such as a hard disc or a ROM (Read Only Memory) 202 built in a computer 200.

Alternatively, the program may be temporarily or permanently stored (recorded) in a removal medium 211 such as a flexible disc, a CD-ROM (Compact Disc Read Only Memory), an MO (Magneto Optical) disc, a DVD (Digital Versatile Disc), a magnetic disc, or a semiconductor memory. The removal medium 211 may be provided as the so-called package software.

Note that the program may be installed from the above described removable medium 211 into the computer 200, or otherwise, wirelessly transferred from a download site to the computer 200 via a satellite for digital satellite broadcasting or wired-transferred to the computer 200 via a network such as LAN (Local Area Network) or the Internet and, at the computer 200, the program that has been transferred in this manner may be received by a communication unit 209 and installed in the memory unit 208.

The computer 200 contains a CPU (Central Processing Unit) 201. An input/output interface 205 is connected to the CPU 201 via a bus 204, and, when a user operates an input unit 206 including a keyboard, a mouse, a microphone, etc. to input an instruction via the input/output interface 205, the CPU 201 executes the program stored in the ROM 202 according thereto. Alternatively, the CPU 201 loads the program stored in the memory unit 208, the program transferred from the satellite or the network, received by the communication unit 209, and installed in the memory unit 208, or the program read out from the removable medium 211 mounted on a drive 210 and installed in the memory unit 208 in a RAM (Random, Access Memory) 203 and executes the program.

Thereby, the CPU 201 performs the processing according to the above described flowchart or the processing executed by the above described configuration in the block diagram. Then, the CPU 201 may output the processing result from an output unit 207 including a display such as an LCD, a speaker, etc., or transmit the result from the communication unit 209, and record the result in the memory unit 208 via the input/output interface 205, for example, according to need.

Here, in the specification, the processing steps describing the program for allowing the computer to execute various processing are not necessarily processed in time series along the sequence described as the flowchart, but include processing executed in parallel or individually (for example, parallel processing or processing using objects).

Further, the program may be processed by one computer or distributed-processed by plural computers. Furthermore, the program may be transferred to a distant computer and executed.

Note that, in the specification, the system refers to entire equipment including plural devices.

Further, the embodiments of the present disclosure is not limited to the above described embodiments, but various changes may be made without departing from the scope of the technology.

Furthermore, the present disclosure may be implemented as the following configurations.

[1] An information processing device including:

a face information acquisition unit that acquires face information on a face region detected from an image containing a face of a participant who is collecting specific information provided in display devices respectively installed at plural locations and using a display device installed at a location;

an identification unit that identifies the participant by checking the acquired face information of the participant against registration information on face regions of pre-registered registrants;

an action history information acquisition unit that selects the registrants similar to the identified participant as candidates from the registrants and acquires action history information on histories of actions when those candidates collect the specific information; and

a presentation unit that presents the acquired action history information to the participant who is using the display unit.

[2] The information processing device according to [1], further including a specific information provision unit that provides the specific information to the candidates identified by a selection result of the participant with respect to the presented action history information.

[3] The information processing device according to [1] or [2], wherein, if it may be impossible to identify the candidates according to the selection result of the participant with respect to the action history information, the presentation unit further presents the action history information of the narrowed down candidates.

[4] The information processing device according to any one of [1] to [3], wherein the action history information at least includes information on installation locations of the display devices at which the candidates have collected the specific information and information on times of the collection.

[5] The information processing device according to any one of [1] to [4], further including a personal identification information acquisition unit that, if the candidates have been identified according to the selection result of the participant with respect to the presented action history information, acquires personal identification information on the identified candidates that can be identified only by the participant, wherein the presentation unit presents the acquired personal identification information to the participant who is using the display device.

[6] The information processing device according to [5], further including a specific information provision unit that provides the specific information to the candidates identified according to the selection result of the participant with respect to the presented personal identification information.

[7] The information processing device according to [2] or [6], wherein the specific information is visit points provided when the participant visits the locations where the display devices are installed in a point rally as an event of accumulating points in a predetermined theme, and

the specific information provision unit provides the visit points as the specific information.

[8] An information processing method including:

by an information processing device,

acquiring face information on a face region detected from an image containing a face of a participant who is collecting specific information provided in display devices respectively installed at plural locations and using a display device installed at a location;

identifying the participant by checking the acquired face information of the participant against registration information on face regions of pre-registered registrants;

selecting the registrants similar to the identified participant as candidates from the registrants and acquiring action history information on histories of actions when those candidates collect the specific information; and

presenting the acquired action history information to the participant who is using the display unit.

[9] A program allowing a computer to function as:

a face information acquisition unit that acquires face information on a face region detected from an image containing a face of a participant who is collecting specific information provided in display devices respectively installed at plural locations and using a display device installed at a location;

an identification unit that identifies the participant by checking the acquired face information of the participant against registration information on face regions of pre-registered registrants;

an action history information acquisition unit that selects the registrants similar to the identified participant as candidates from the registrants and acquires action history information on histories of actions when those candidates collect the specific information; and

a presentation unit that presents the acquired action history information to the participant who is using the display unit.

[10] An information processing system including display devices and an information processing device,

each of the display devices including
an imaging unit that takes an image containing a face of a participant who is collecting specific information provided in display devices respectively installed at plural locations and using a display device installed at a location,
a face detection unit that detects a face region of the participant from the taken image,
a first transmitting unit that transmits face information on the detected face region to the information processing device,
a first receiving unit that receives action history information on histories of actions when registrants as candidates similar to the participant identified by checking the face information against registration information on face regions of pre-registered registrants transmitted from the information processing device collect the specific information,
a presentation unit that presents the received action history information to the participant, and
a selection input unit that accepts selection by the participant with respect to the presented action history information,

wherein the first transmitting unit transmits an accepted selection result by the participant to the information processing device,

the information processing device including
a second receiving unit that receives the face information transmitted from the display device,
an identification unit that identifies the participant by checking the received face information against the registration information,
an action history information acquisition unit that selects the registrants similar to the identified participant as candidates from the registrants and acquires the action history information of those candidates,
a second transmitting unit that transmits the acquired action history information to the display device, and
a specific information provision unit that provides the specific information to the candidates identified according to a selection result of the participant transmitted from the display device.

The present disclosure contains subject matter related to that disclosed in Japanese Priority Patent Application JP 2011-177830 filed in the Japan Patent Office on Aug. 16, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a face information acquisition unit that acquires face information on a face region detected from an image containing a face of a participant who is collecting specific information provided in display devices respectively installed at plural locations and is using a display device installed at a location;
an identification unit that identifies the participant by checking the acquired face information of the participant against registration information on face regions of pre-registered registrants;
an action history information acquisition unit that selects the registrants similar to the identified participant as candidates from the registrants and acquires action history information on histories of actions when those candidates collect the specific information; and
a presentation unit that presents the acquired action history information to the participant who is using the display unit.

2. The information processing device according to claim 1, further comprising a specific information provision unit that provides the specific information to the candidates identified by a selection result of the participant with respect to the presented action history information.

3. The information processing device according to claim 2, wherein, if it may be impossible to identify the candidates according to the selection result of the participant with respect to the action history information, the presentation unit further presents the action history information of the narrowed down candidates.

4. The information processing device according to claim 1, wherein the action history information at least includes information on installation locations of the display devices at which the candidates have collected the specific information and information on times of the collection.

5. The information processing device according to claim 1, further comprising a personal identification information acquisition unit that, if the candidates have been identified according to the selection result of the participant with respect to the presented action history information, acquires personal identification information on the identified candidates that can be identified only by the participant, wherein the presentation unit presents the acquired personal identification information to the participant who is using the display device.

6. The information processing device according to claim 5, further comprising a specific information provision unit that provides the specific information to the candidates identified according to the selection result of the participant with respect to the presented personal identification information.

7. The information processing device according to claim 2, wherein the specific information is visit points provided when the participant visits the locations where the display devices are installed in a point rally as an event of accumulating points in a predetermined theme, and the specific information provision unit provides the visit points as the specific information.

8. An information processing method comprising:
allowing an information processing device to
acquire face information on a face region detected from an image containing a face of a participant who is collecting specific information provided in display devices respectively installed at plural locations and using a display device installed at a location;
identify the participant by checking the acquired face information of the participant against registration information on face regions of pre-registered registrants;
select the registrants similar to the identified participant as candidates from the registrants and acquiring action history information on histories of actions when those candidates collect the specific information; and
present the acquired action history information to the participant who is using the display unit.

9. A program allowing a computer to function as:
a face information acquisition unit that acquires face information on a face region detected from an image containing a face of a participant who is collecting specific information provided in display devices respectively installed at plural locations and using a display device installed at a location;
an identification unit that identifies the participant by checking the acquired face information of the participant against registration information on face regions of pre-registered registrants;
an action history information acquisition unit that selects the registrants similar to the identified participant as candidates from the registrants and acquires action history information on histories of actions when those candidates collect the specific information; and
a presentation unit that presents the acquired action history information to the participant who is using the display unit.

10. An information processing system comprising:
display devices; and
an information processing device,
each of the display devices including
an imaging unit that takes an image containing a face of a participant who is collecting specific information provided in display devices respectively installed at plural locations and using a display device installed at a location,
a face detection unit that detects a face region of the participant from the taken image,
a first transmitting unit that transmits face information on the detected face region to the information processing device,
a first receiving unit that receives action history information on histories of actions when registrants as candidates similar to the participant identified by checking the face information against registration information on face regions of pre-registered registrants transmitted from the information processing device collect the specific information,
a presentation unit that presents the received action history information to the participant, and
a selection input unit that accepts selection by the participant with respect to the presented action history information,
wherein the first transmitting unit transmits an accepted selection result by the participant to the information processing device,
the information processing device including
a second receiving unit that receives the face information transmitted from the display device,
an identification unit that identifies the participant by checking the received face information against the registration information,
an action history information acquisition unit that selects the registrants similar to the identified participant as candidates from the registrants and acquires the action history information of those candidates,
a second transmitting unit that transmits the acquired action history information to the display device, and
a specific information provision unit that provides the specific information to the candidates identified according to a selection result of the participant transmitted from the display device.
